(19) United States
(12) Patent Application Publication
(10) Pub. No.: US 2006/0226390 A1
(43) Pub. Date: Oct. 12, 2006

(54) Adjusting lever for a gas flow controller

(76) Inventor: Hsu-Nan Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/103,581

(22) Filed: Apr. 12, 2005

(51) Int. Cl. F16K 5/00

(52) U.S. Cl. 251/304

(57) ABSTRACT

An adjusting lever for a gas flow controller includes a stator disposed at top a groove and inserted with a washer to pack the adjusting lever to an inner wall of a locking hole of a rotor to prevent gas leak. A chamfer is provided at one end of the stator. A blank flange is provided around an opening in front of the locking hole of the rotor. The blank flange is axially punched into a flange by mechanical force to wrap up the chamfer thus to pivot and secure the adjusting lever to the rotor.

### BACKGROUND OF THE INVENTION

(a) Field of the Invention

The present invention relates to an adjusting lever for a gas flow controller, and more particularly, to one composed of a stator, a groove on the stator to be inserted with a washer, and a chamfer provided at one end of the stator. A blank flange is provided at an opening in the front of a locking hole of a rotor and the blank flange is punched and compressed axially by mechanical force to form a flange so as to flush against the chamfer to pivot the adjusting lever to the rotor.

(b) Description of the Prior Art

A gas flow controller is usually adapted to an appliance operating with gas as the fuel to maintain a constant combustion temperature by controlling the gas flow depending on the changed combustion temperature. As illustrated in FIGS. 9 and 10 of the accompanying drawings, a conventional gas flow controller includes a casing (A) containing a passage (A1) to admit the flow of gas. An inlet (A2) and an outlet (A3) are provided on respective ends of the passage (A1). A terraced opening (A4) is disposed between the inlet (A2) and the outlet (A3). A hollow rotor (B) is provided in the inlet (A2). A connection sleeve (B1) extends outwardly from one end of the rotor (B) and is separately fixed to a knob (irrelevant to the present invention thus not illustrated) to be operated by the user.

An inching lever (C) is packed into the rotor (B). A spring (C1) is inserted onto the inching lever (C) to compress against a plug (C2) so to pack against the inner wall of the rotor (B). A C-shaped clamp (C3) is locked to one end of the inching lever (C) while the C-shaped clamp (C3) and its washer hold against another end of the spring (C1). The surface on one end of the inching lever (C) is cut with a slot (C4) for the operation of a hand tool, e.g., a flat head screwdriver while the other end of the inching lever (C) is disposed with a connection section (C5). The connection section (C5) is provided with a slot (C6) to receive insertion of a pin (D1) protruding from one end of a mobile base (D). A valve (D2) is inserted near the other end of the mobile base (D) to adjust the flow of the gas passing through the opening (A4). The other end of the mobile base (D) is screwed to a temperature detector (E). An elastic member (E1) is provided into the temperature detector (E) and a temperature detection wire (E2) is connected to a heat source to detect the temperature of the heat source. The elastic member (E1) expands to push the valve (D2) to move.

Accordingly, with the temperature detection wire (E2) mounted to where in the vicinity of the heat source, the temperature of the heat source varies when the temperature detection wire (E2) gets too close to or far away from the heat source depending on the mounting location of the temperature detection wire (E2). As a result, the relative travel of the valve (D2) pushed by the elastic member (E1) to move from its initial location to the opening (A4) is vulnerable to create error thus to fail the purpose of correct adjustment of the gas flow. Therefore, upon completing the mounting of the temperature detection wire (E2), the inching lever (C) must be turned to adjust for an optimal initial location for the valve (D2). In doing so, the rotor (B) is fixed first by having a pair of pincer pliers to clamp onto the connection sleeve (B1), the a hand too, i.e., flat head screwdriver is used to force turning the inching lever (C) to drive the pin (D1) of the mobile base (D) in conjunction with the slot (C6) of the connection section (C5) disposed at another end of the inching lever (C). The initial location of the valve (D2) away from the opening (A4) is adjusted when the mobile base (D) rotates and moves since the other end of the mobile base (D) is screwed to the temperature detector (E). Upon completing the adjustment for the initial location of the valve (D2) and the heat source is started, the rotor (B) is rotated to drive the inching lever (C) to move from its initial location to adjust the distance between the valve (D2) and the opening (A4) thus to decide on the gas flow. Once the temperature of the heat source rises, the temperature detection wire (E2) of the temperature detector (E) will cause the elastic member (E1) to expand and protrude to push the valve (D2) getting closer to the opening (A4), thus to reduce the gas flow in the passage (A1) and to diminish the heat source for bringing down the temperature. Once the temperature of the heat source gets too low, the elastic member (E1) retracts to move inward to bring the valve (D2) way out of the opening (A4) for increasing the flow of the gas to increase the heat source for raising its temperature.

However, in such a structure the inching lever (C) is packed in the rotor (B) by having the spring (C1) compressing against the plug (C2). The prior art is at the risk of gas leakage due to poor airtight performance since the plug (C2) for being compressed by the spring (C1) is vulnerable to be deformed. Meanwhile, another end of the spring (C1) holds against the C-shaped clamp (C3) and its washer that are locked to the inching lever (C) to secure the spring (C1) from falling out of place. Whereas the C-shaped clamp (C3) is mounted manually, the spring force of the spring (C1) prevents easy assembly and may hurt the worker.

### SUMMARY OF THE INVENTION

The primary purpose of the present invention is to provide an improved adjusting lever for a gas flow controller to eliminate those problems found with the prior art. To achieve the purpose, a stator of the adjusting lever is provided with a groove with a washer to pack the adjusting lever onto the inner wall of a locking hole of a rotor; a chamfer is provided at one end of the stator; a blank flange is provided around an opening in front of the locking hole of the rotor; and the blank flange is punched axially by mechanical force to form a flange that wraps up and holds against the adjusting lever thus to pivot the adjusting level to the rotor. The present invention provides the following advantages:

1. Airtight. The stator of the adjusting lever is provided with the groove inserted with the washer to pack the adjusting lever to the inner wall of the locking hole of the rotor to achieve airtight status for preventing gas leakage.

2. Easy assembly. The chamfer is provided at one end of the stator and the blank flange is provided around an opening in front of the locking hole of the rotor; and the blank flange is punched axially by mechanical force to form a flange that wraps up and holds against the adjusting lever thus to pivot the adjusting level to the rotor. Accordingly, the adjusting lever is prevented from falling out of its place while allowing easy assembly for saving labor cost.

### BRIEF DESCRIPTION OF THE DRAWINGS

FIG. 1 is a perspective view of the present invention, partially sectioned.

FIG. 2 is a perspective view of the present invention as assembled, partially sectioned.

FIG. 3 is a schematic view showing that the present invention is installed in a casing.

FIG. 4 is a sectional view showing that present invention is installed in the casing.

FIG. 5 is a schematic view showing the turning of an adjusting lever of the present invention.

FIG. 6 is a schematic view showing the turning of a rotor of the present invention.

FIG. 7 is a schematic view showing the operation of an elastic member when the present invention detects a higher temperature.

FIG. 8 is a schematic view showing the operation of the elastic member when the present invention detects a lower temperature.

FIG. 9 is a schematic view showing an internal structure of a gas flow controller of a prior art.

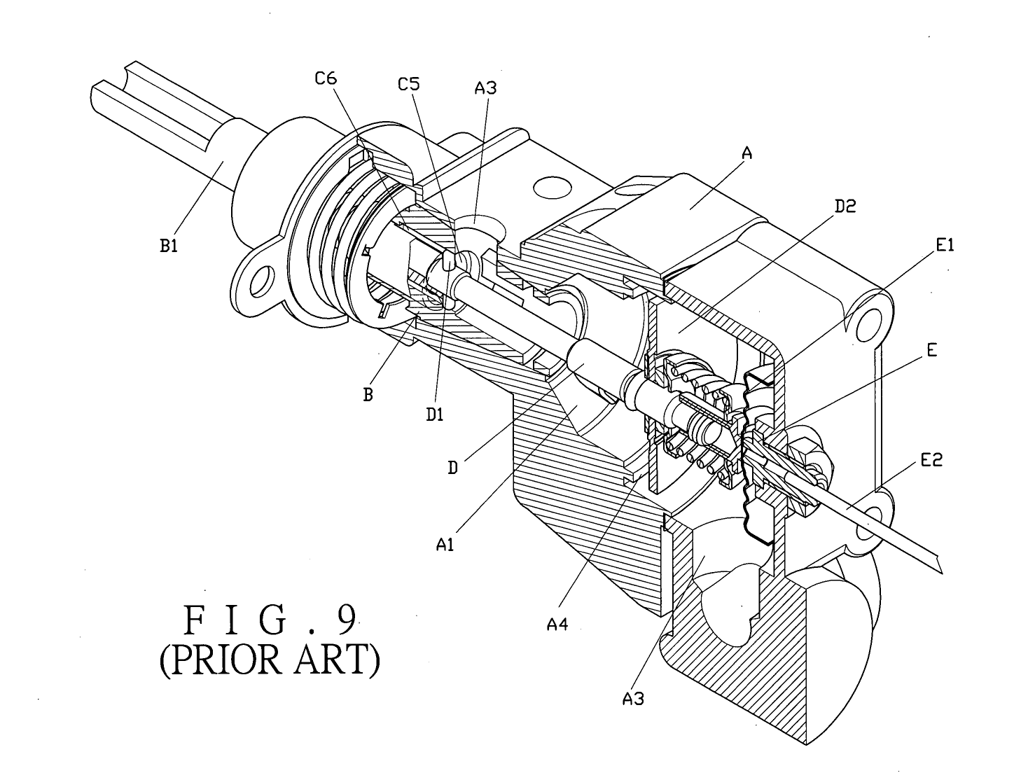

FIG. 10 is a cross-sectional view of the prior art.

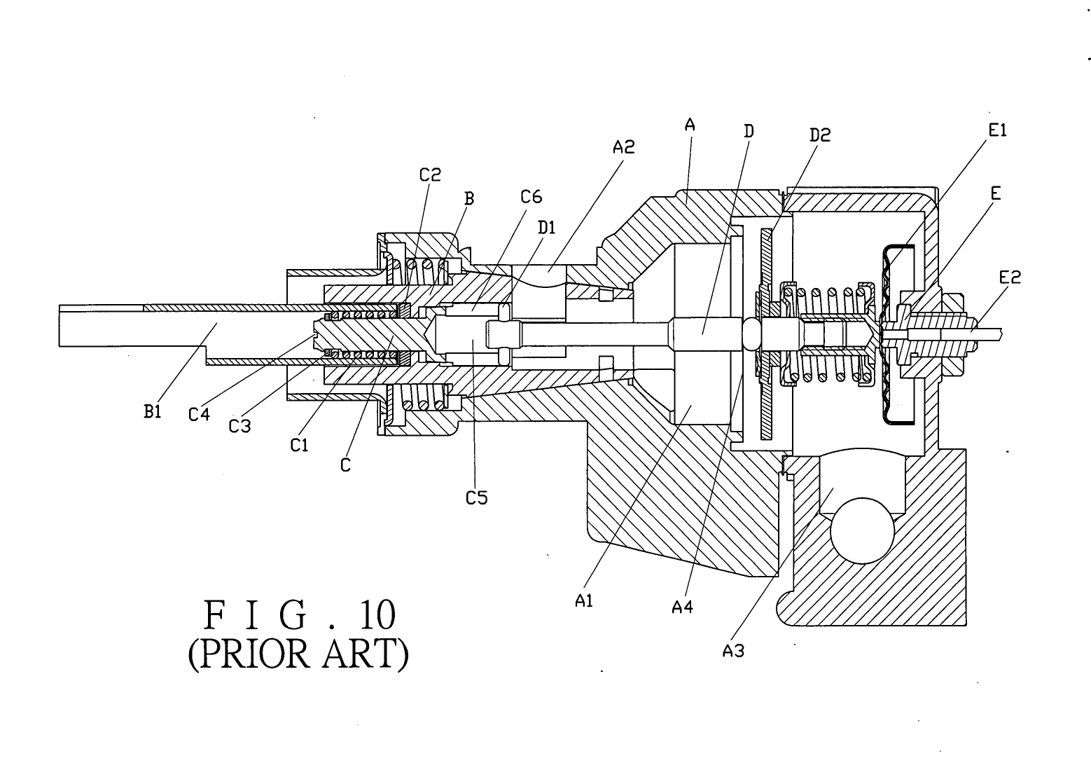

### DETAILED DESCRIPTION OF THE PREFERRED EMBODIMENTS

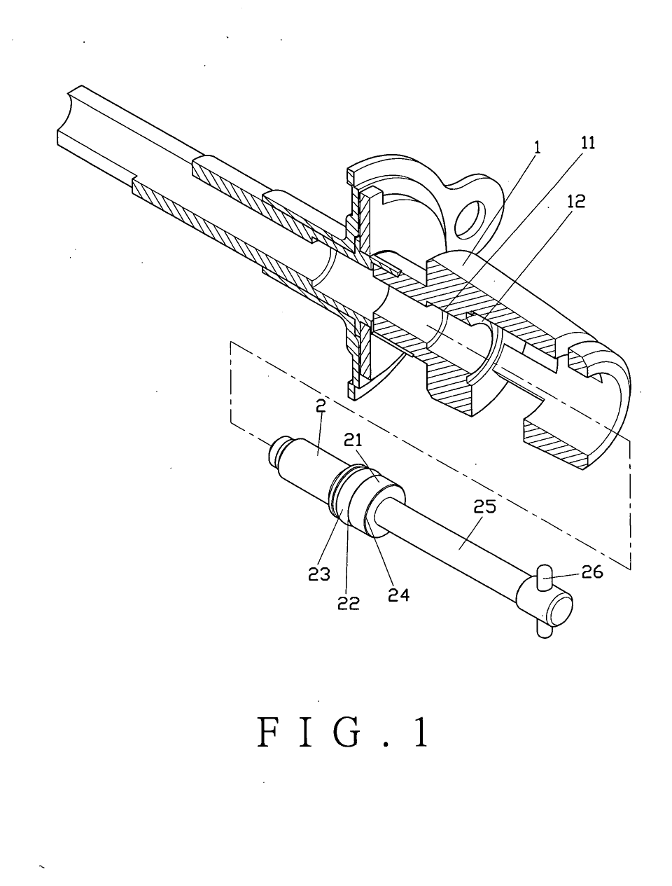

Referring to FIG. 1, the present invention comprises a hollow rotor (1). A locking hole (11) is provided in the rotor (1) and a blank flange (12) is provided around an opening in front of the locking hole (11). An adjusting lever (2) is packed and secured in the locking hole (11) of the rotor (1). A stator (21) is provided at the middle section of the adjusting lever (2). The stator (21) is provided with a circular groove (22). A washer (23) is inserted into the groove (22) to pack the adjusting lever (2) against the inner wall of the locking hole (11) of the rotor (1). A chamfer (24) is provided at one end of the stator (21) and a connection section (25) adapted with a pin (26) protrudes from the front end of the stator (21).

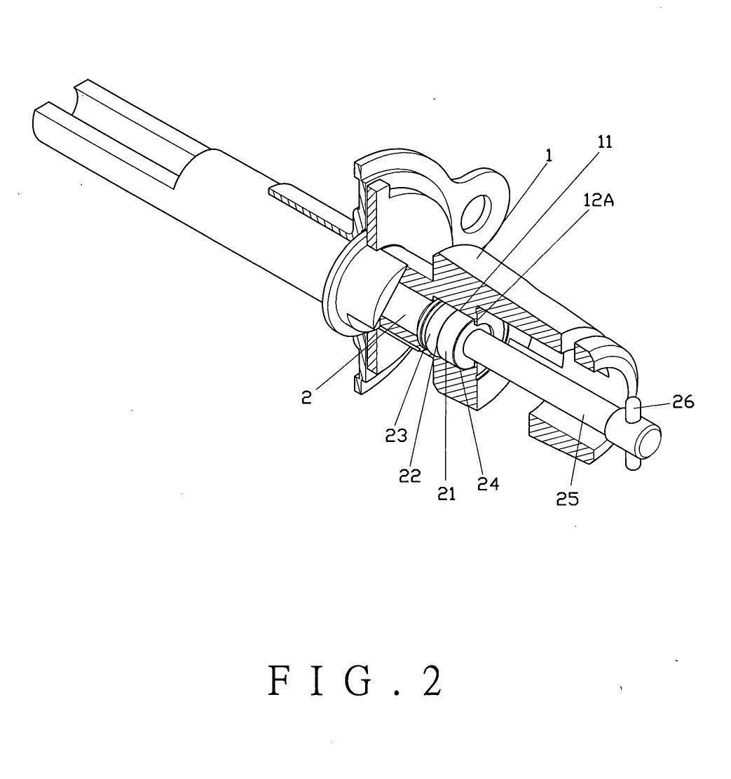

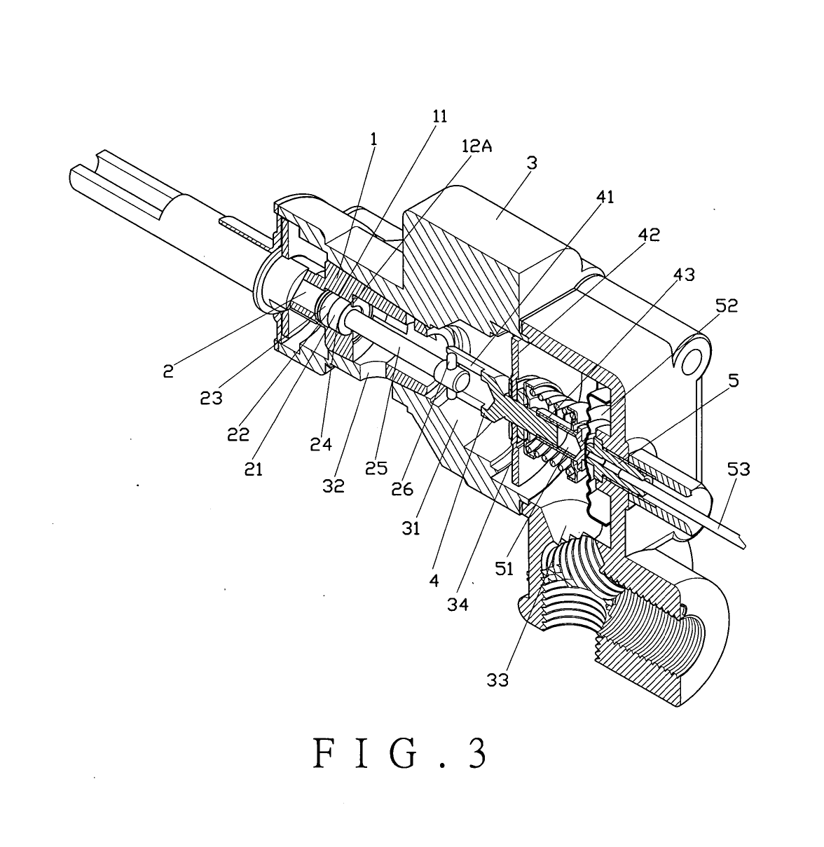

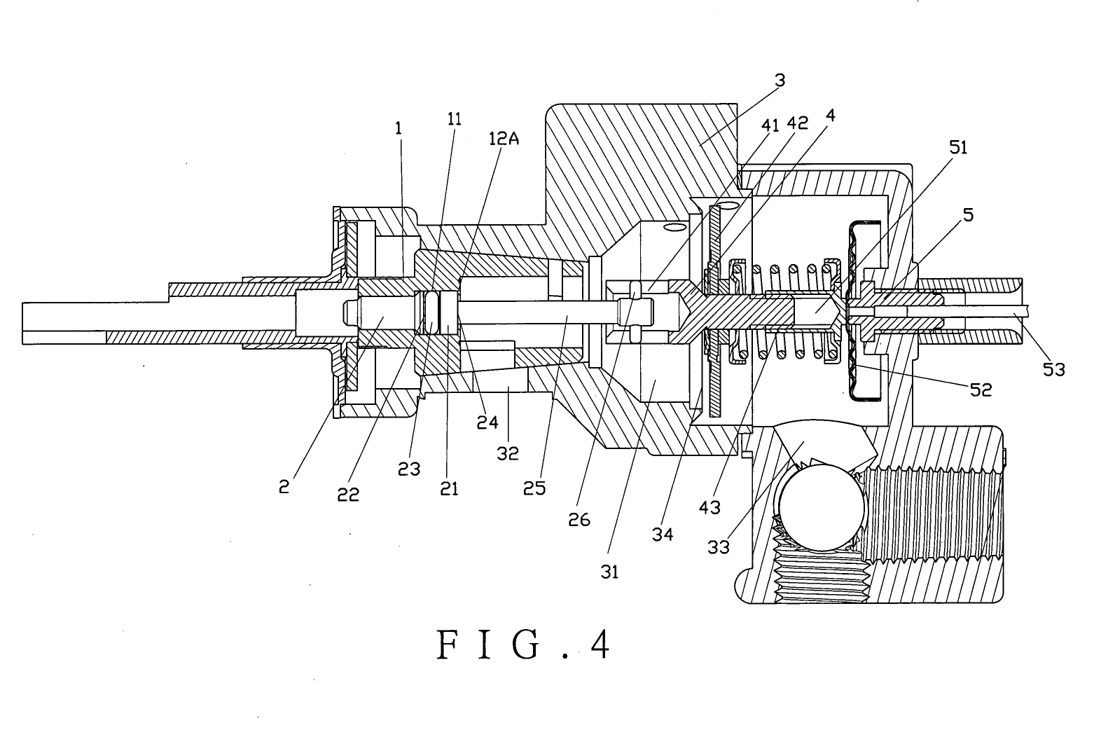

While assembling as illustrated in FIG. 2, the adjusting lever (2) is placed in the locking hole (11) of the rotor (1) and packed in position against the inner wall of the rotor (1) by means of the washer (23) mounted in the groove (22) of the adjusting lever (2). The blank flange (12) of the locking hole (11) of the rotor (1) is made slightly protruding out of the front edge of the chamfer (24) of the adjusting lever (2). The blank flange (12) is axially punched by mechanical force to form a flange (12A) to wrap up and hold against the chamfer (24) of the adjusting lever (2) thus to incorporate the adjusting lever (2) and the rotor (1) into one piece without being separating from each other. Both the adjusting lever (2) and the rotor (1) are then secured in a casing (3) of a gas flow controller as illustrated in FIGS. 3 and 4.

The casing (3) comprises a passage (31) to admit the flow of the gas and an inlet (32) and an outlet (33) are provided at respective ends of the passage (31). A terraced opening (34) is provided between the inlet (32) and the outlet (33). The rotor (1) is secured at the inlet (32) of the casing (3).

A mobile base (4) connected to and driven by the adjusting lever (2) is provided at one end a slot (41) to receive insertion of the pin (26) of the adjusting lever (2). A valve (42) is provided near the other end of the mobile base (4) for adjusting the flow of the gas passing through the opening (34). The distal end of the mobile base (4) from the slot (41) is provided with a threaded section (43).

A temperature detector (5) connected to the mobile base (4) is provided with a screwed hole (51) at one end to engage with the threaded section (43) of the mobile base (4). An elastic member (52) disposed in the temperature detector (5) is connected with a temperature detection wire (53) protruding outward from the casing (3) to be connected to a heat source to detect the temperature of the heat source. The elastic member (52) expands or retracts depending on the temperature detected. The temperature detector (5) is fixed at the outlet (33) of the casing (3) before sealing the casing (3) to complete assembly.

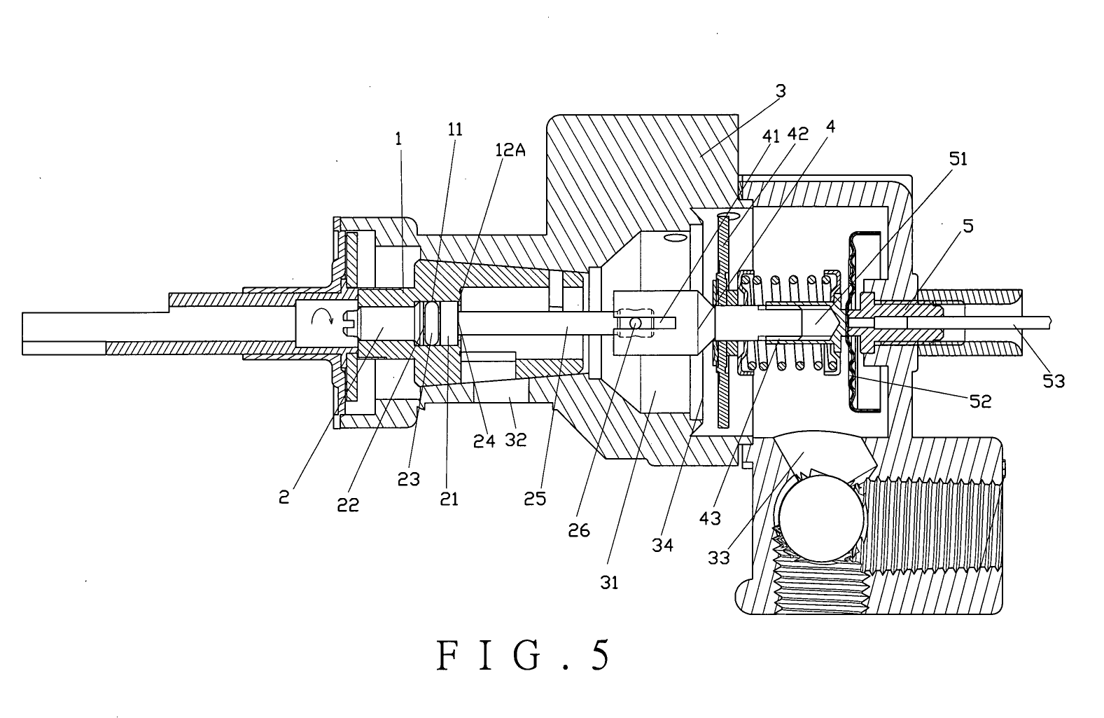

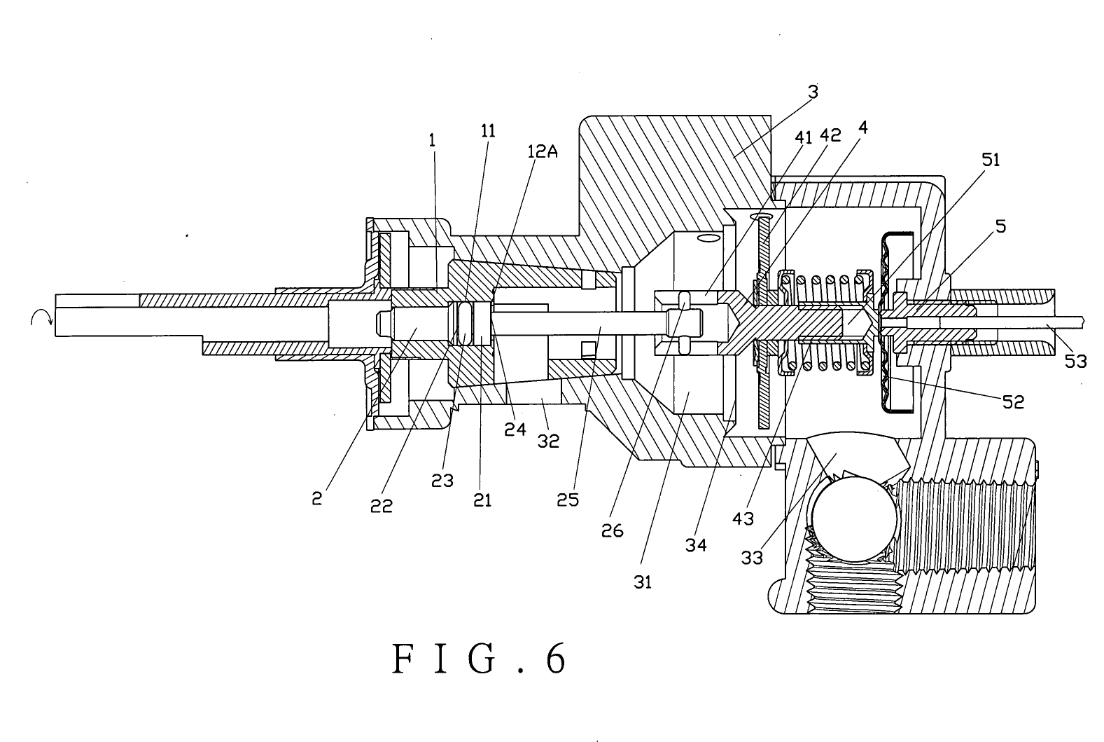

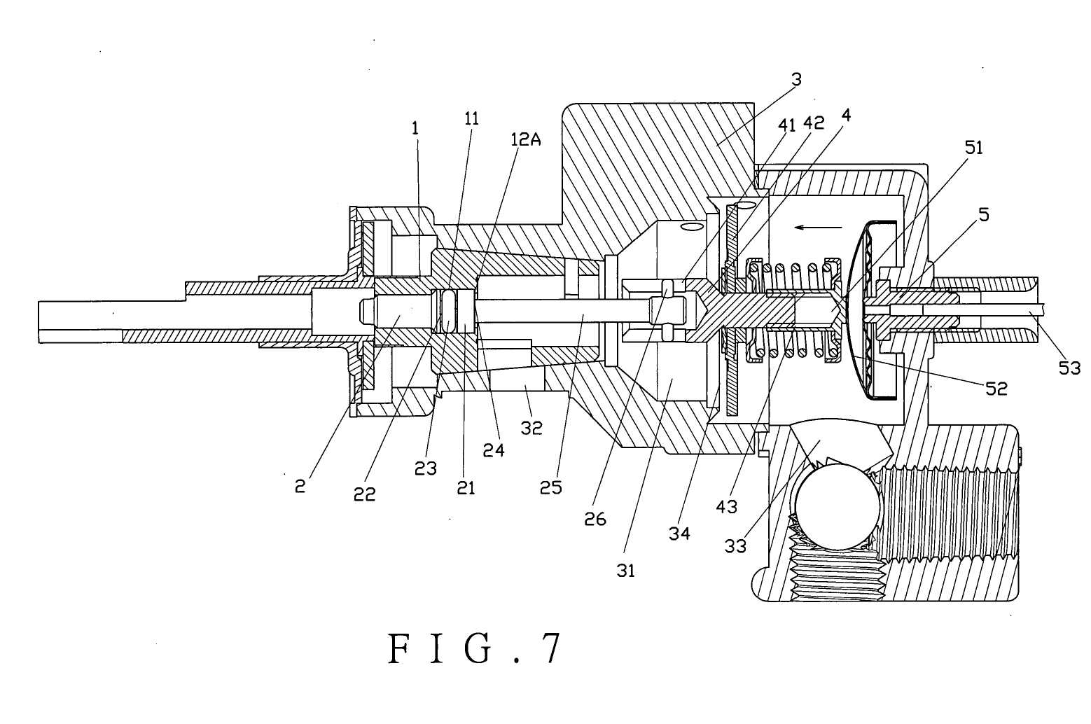

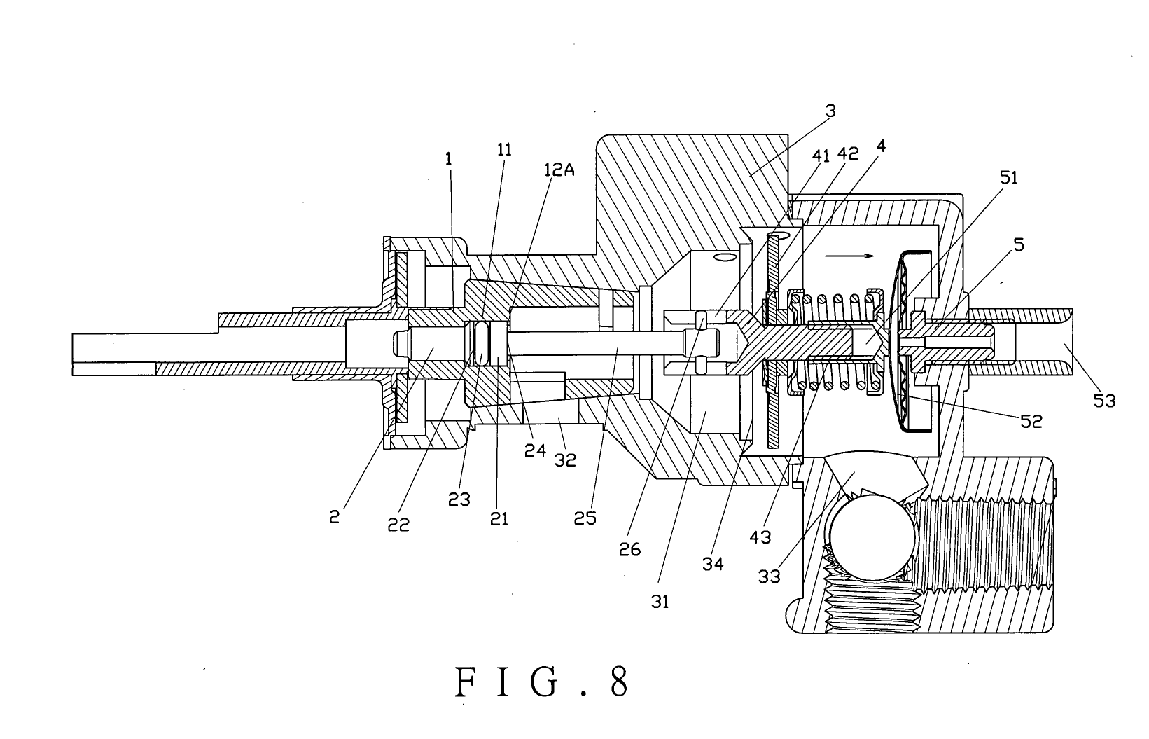

In use, as illustrated in FIG. 5, when the temperature detection wire (53) is initially installed in the vicinity of the heat source, its relative distance to the heat source varies depending on the location of the installation of the temperature detection wire (53). Therefore, the valve (42) must be first adjusted to an optimal initial location to avoid affecting the gas flow control due to poor initial location. A hand tool, e.g., a pair of pincer pliers, is used to secure the rotor (1) in place and another type of hand tool, e.g., a flat head screwdriver is used to force turning the adjusting lever (2). As the adjusting lever (2) turns, the slot (41) of the mobile base (4) also turns by means of the pin (26) protruding from the connection section (25). In conjunction with the threaded section (43) and the screwed hole (51), the mobile base (4) is moved to adjust the optimal initial location for the valve (42) in relation to the opening (34). Upon the initial location of the valve (42) is completed and the heat source is started, the rotor (1) is rotated as illustrated in FIG. 6. With the washer (23) of the adjusting lever (2) packing against and secured onto the inner wall of the rotor (1), the adjusting lever (2) is driven to start rotating. The slot (41) of the mobile base (4) is further driven by means of the pin (26) protruding from the connection section (25). Once the mobile base (4) moves, the valve (42) is adjusted to move from its initial location to change the distance between the valve (42) and the opening (34) thus to determine the flow of the gas passing through the passage (31). When the temperature of the heat source rises as illustrated in FIG. 7, the temperature detection wire (53) of the temperature detector (5) detects the higher temperature, and the elastic member (52) expands to push the valve (42) towards the opening (34) to reduce the gas flow, diminish the heat source and lower the temperature. On the contrary, as illustrated in FIG. 8, when the temperature of the heat source stays lower, the elastic member (52) retracts and moves inwardly to take the valve (42) away from the opening (34) to increase the gas flow, thus to increase the heat source to raise its temperature for achieving the purpose of gas flow control.

I claim:

1. An adjusting lever for a gas flow controller operating in conjunction with a rotor, said rotor comprising a locking hole therein, a blank flange being provided around an opening in front of said locking hole, said adjusting lever being provided with a stator, said stator comprising a circular groove, said groove being inserted with a washer, a chamfer being provided at one end of said stator, said adjusting lever being packed against an inner wall of said locking hole of said rotor by means of said washer, said blank flange being axially punched into a flange by mechanical force, said flange wrapping up and holding against said chamfer of said adjusting lever to pivot said adjusting lever to said rotor.
